(19) United States
(12) Patent Application Publication
(10) Pub. No.: US 2011/0304734 A1
(43) Pub. Date: Dec. 15, 2011

(54) METHOD AND APPARATUS FOR OPERATING A VIDEO-BASED DRIVER ASSISTANCE SYSTEM IN A VEHICLE

(75) Inventor: Michael Walter, Widnau (CH)

(73) Assignee: ADC Automotive Distance Control Systems GmbH, Lindau/Bodensee (DE)

(21) Appl. No.: 13/146,987

(22) PCT Filed: Jan. 28, 2010
(86) PCT No.: PCT/DE2010/000086

§ 371 Date: Aug. 31, 2011

(30) Foreign Application Priority Data
Feb. 6, 2009 (DE) 10 2009 007 842.8

(51) Int. Cl. H04N 7/18

(52) U.S. Cl. 348/148; 348/E07.085

(57) ABSTRACT

Disclosed herein is a method for operating a video-based driver assistance system in a vehicle (F), wherein, by using image data recorded by an imaging unit and processed by an image processing unit, a vehicle environment and/or at least one object (O) in the vehicle environment and/or status data are determined. In the determination of the vehicle environment, of the object (O) in the vehicle environment and/or of the status data, a pixel offset (P) present in the image data of consecutive images is determined and compensated for. Also disclosed is an apparatus for operating a video-based driver assistance system in a vehicle (F).

### CROSS REFERENCE TO RELATED APPLICATIONS

This application is the U.S. National Phase Application of PCT International Application No. PCT/DE2010/000086, filed Jan. 28, 2010, which claims priority to German Patent Application No. 10 2009 007 842.8, filed Feb. 6, 2009, the contents of such applications being incorporated by reference herein.

### FIELD OF THE INVENTION

The invention relates to a method for operating a video-based driver assistance system in a vehicle. The invention relates further to an apparatus for operating a video-based driver assistance system in a vehicle.

### BACKGROUND OF THE INVENTION

It is known from prior art that driver assistance systems of a vehicle are operated as a function of data of different sensors. This can be for example video-based driver assistance systems, which are controlled on the basis of image data.

For determining such image data as well as for identifying objects and their three-dimensional positioning object models are used. With the adaptation of an object model to a 3D-scatter plot with known methods (Schmidt, J., Woehler, C, Krueger, L, Goevert, T., Hermes, C, 2007. 3D Scene Segmentation and Object Tracking in Multiocular Image Sequences. Proc. Int. Conf. on Computer Vision Systems (ICVS), Bielefeld, Germany, which is incorporated by reference) it often comes to ambiguities (incorrect positive assignments). The object is multiply found in the scatter plot, although it present not so often and/or not at all. A further problem, which refers to model adaptation, is the inaccuracy of the adaptation. Current conventional stereo methods are usually based on the search for features (edges, points, corners, pixel blocks, etc.) in a left and a right image and the subsequent assignment of identical/similar features to each other. Alternatively, often also the contents of local image windows are examined in terms of their similarity. The so-called disparity value is then detected by determining the offset to each other of the assigned features or image windows in the left and in the right image. With the perquisite of a calibrated camera system then from the disparity value a depth value can be assigned to the pertaining pixel by triangulation. In some cases this leads to incorrect depth values due to an incorrect assignment. This happens frequently with repeating structures in the image, such as e.g. fingers of the hand, forest, etc. with edge-based stereo methods. The 3D-dots resulting from the incorrect assignment are called false correspondences and/or outliers. Dependent on the choice of features this effect arises more or less frequently, however, without further assumptions can in principle be never excluded. These false correspondences affect the adaptation of the object model in negative manner, since they lead to a deterioration of the representation of the scene by the 3D-scatter plot.

The literature knows various methods, which deal with the problem of false correspondences. A majority of the methods tries to recognize the outliers in order to eliminate them subsequently. A disadvantage here is the decreasing number of 3D-dots and/or the caused loss of information. Other methods [Hirschmueller, H., 2005. Accurate and Efficient Stereo Processing by Semi-Global Matching and Mutual Information, Proc. IEEE Conf. on Computer Vision and Pattern Recognition, San Diego, the USA.], which is incorporated by reference, again try to suppress the problem for example by assuming smooth surfaces in sections. By such assumptions of evenness fine structures are no longer recognizable, what leads to a loss of information. In addition, these methods supply good results only where it actually can be reckoned with smooth surfaces.

### SUMMARY OF THE INVENTION

The invention relates to an improved method and an improved apparatus for operating a video-based driver assistance system in a vehicle.

According to one aspect of the invention, a method for operating a video-based driver assistance system in a vehicle (F) is disclosed. According to the method, a vehicle environment and/or at least one object (O) in the vehicle environment and/or status data are determined by means of image data recorded by an imaging unit (1.1) and processed by an image processing unit (1.2). The determination of the vehicle environment, of the object (O) in the vehicle environment and/or of the status data, a pixel offset (P) present in the image data of consecutive images is determined and compensated for. According to another aspect of the invention an apparatus for operating a video-based driver assistance system in a vehicle (F) is disclosed. The apparatus comprises an imaging unit (1.1) for recording image data, an image processing unit (1.2) for processing the image data and a control unit (1.4) for determining a vehicle environment and/or at least one object (O) in the vehicle environment and/or status data from the image data. The control unit (1.4) is connected with at least one rotation rate sensor (1.3) and/or at least one acceleration sensor (1.5, 1.6) in such a manner that in the determination of the vehicle environment, of the object (O) in the vehicle environment and/or of the status data a pixel offset (P) present in the image data of consecutive images can be determined and compensated for on the basis of the detected rotation rates (R).

With the method according to aspects of the invention for operating a video-based driver assistance system in a vehicle, by means of image data recorded by an imaging unit and processed by an image processing unit a vehicle environment and/or at least one object in the vehicle environment and/or status data are determined.

According to aspects of invention in the determination of the vehicle environment, of the object in the vehicle environment and/or of the status data, a pixel offset present in the image data of consecutive images is determined and compensated for. This results in advantageous manner in that a very accurate determination and consequently also a representation of the vehicle environment and/or of the at least one object in the vehicle environment and/or of the status data is possible. The status data are for example distances of the vehicle to stationary or moving objects, speeds and/or accelerations of these objects. From the accurate determination again an optimized control of the driver assistance system and thus an increase of the safety of vehicle occupants and other road users result.

In accordance with a further development of the method according to aspects of the invention a pixel offset is determined resulting from a change of the pitch angle, yaw angle and rolling angle, so that a pitch, yaw or rolling motion does not have a negative influence on determination of the vehicle environment, of the object in the vehicle environment and/or of the status data or with when the pitch, yaw and rolling angle are known, the influence can be compensated, respectively.

Thereby, from the change of the pitch angle, yaw angle and rolling angle preferably a change of position of at least one pixel in the consecutive images is determined, wherein on the basis of the determined change of position of the pixel(s) a pixel offset to be expected is determined. Thereby, it is advantageously not required to determine a change of position for each pixel of the image so that a high processing speed and resulting dynamics can be achieved in the determination and representation of the vehicle environment, of the object in the vehicle environment and/or of the status data.

The changes of the pitch angle, yaw angle and rolling angle are determined in particular from detected rotation rates during the recording of two consecutive images. For determining the rotation rates a rotational speed of a body along an axis of rotation is understood. For determining the rotation rates the rotational speed of the vehicle and/or the imaging unit is detected around a transverse, vertical and/or longitudinal axis of the same. By integrating the detected rotational speed the pitch angle, yaw angle and/or rolling angle, in which the vehicle and/or the imaging unit have rotated around the transverse, vertical and/or longitudinal axis within a certain time, can be determined. Here, the certain time is the time, which is necessary to record two consecutive images. Since the rotation rates can be determined very precisely, very accurate results can be obtained in simple manner in the determination of the change of the pitch angle, yaw angle and rolling angle of the vehicle.

For determining the rotation rates at least one rotation rate sensor is provided, by means of which the rotation rates during the recording of at least two consecutive images can determined. From these rotation rates determined during at least two consecutive images the pixel offset can be determined at low expenditure and with simultaneously high accuracy.

Alternatively or additionally by means of at least one acceleration sensor a longitudinal acceleration and/or a transverse acceleration of the vehicle during at least two consecutive images are determined and from the detected longitudinal acceleration and/or transverse acceleration on the basis of a vehicle model the rotation rates of the vehicle are determined. Due to the redundant determination of the rotation rates by means of the acceleration sensors and of the at least one rotation rate sensor the method is very robust against disturbance variables and is thus very reliable.

In accordance with an advantageous embodiment of the method according to aspects of the invention a deviation of the determined rotation rates from a nominal value is determined by means of a filtration in the event that the vehicle is moving. This filtration for example is a low-pass filtering, wherein by the filtration of the deviation, which arises for example due to temperature variations during the travel of the vehicle, measurement errors are minimized and thus the accuracy of the measurement is increased.

The apparatus according to aspects of invention for operating a video-based driver assistance system in a vehicle comprises an imaging unit to record image data, an image processing unit for processing the image data and a control unit for determining a vehicle environment and/or at least one object in the vehicle environment and/or status data from the image data. According to aspects of invention the control unit is connected with at least one rotation rate sensor and/or at least one acceleration sensor in such manner that in the determination of the vehicle environment, of the object in the vehicle environment and/or of the status data a pixel offset present in the image data of consecutive images can be determined and compensated for on the basis of the detected rotation rates.

The at least one rotation rate sensor and/or the at least one acceleration sensor are arranged preferably directly at or in the imaging unit, so that no conversion of the detected rotation rates to a position of the imaging unit is required.

Further, the rotation rate sensor is a sensor with three-dimensional detection area, by means of a which simultaneously a pitch angle, yaw angle and rolling angle of the vehicle can be detected, so that in advantageous manner only one sensor is required for determining the rotation rates of the vehicle. This results in a reduced expenditure of material and connection as well as an ensuing cost advantage.

In a particularly advantageous embodiment of the apparatus according to aspects of invention two acceleration sensors are arranged at right angles to each other directly at or in the imaging unit, wherein by means of an acceleration sensor a longitudinal acceleration and by means of the other acceleration sensor a transverse acceleration of the vehicle can be detected. In simple manner from the longitudinal and transverse acceleration the rotation rates of the vehicle, in particular while using a vehicle model stored in a storage unit, can be determined, the use of the acceleration sensors for the determination of the rotation rates leading to a high robustness of the apparatus.

When using the acceleration sensors in addition to the rotation rate sensor or the rotation rate sensors, due to a redundancy of the detecting units, i.e. the acceleration sensors and the rotation rate sensor or the rotation rate sensors, a high reliability of the apparatus is achieved.

### BRIEF DESCRIPTION OF THE DRAWINGS

The invention is best understood from the following detailed description when read in connection with the accompanying drawings. Included in the drawings is the following figures:

FIG. 1 shows schematically a vehicle with an apparatus for controlling a video-based driver assistance system and an object located ahead of the vehicle,

FIG. 2 shows schematically a block diagram of the apparatus in accordance with FIG. 1 and of the driver assistance system.

### DETAILED DESCRIPTION OF THE DRAWINGS

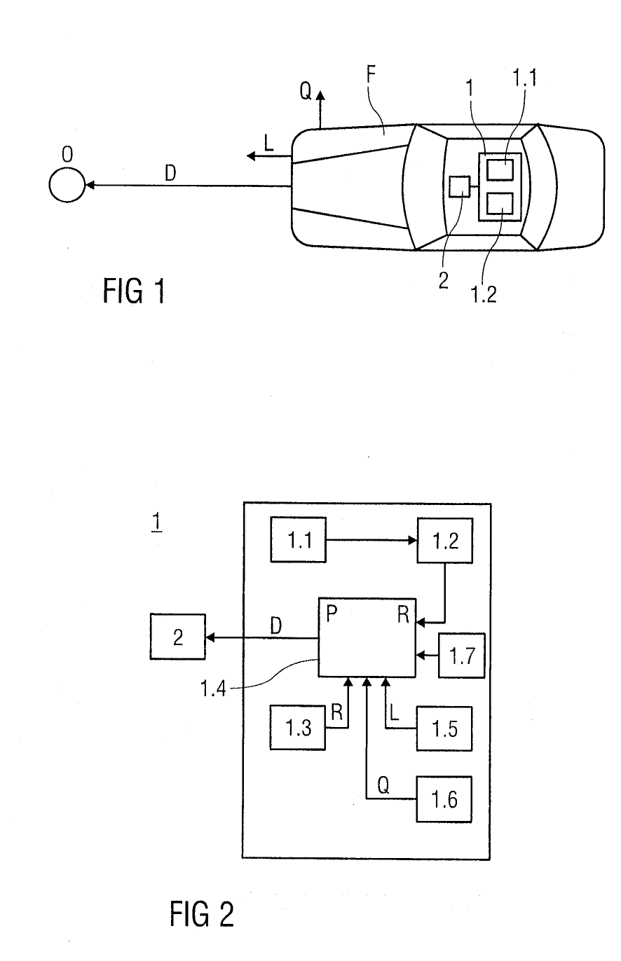

In FIG. 1 a vehicle F with an apparatus 1 for controlling a video-based driver assistance system 2 and an object O located ahead of the vehicle are shown. The object O for example is another vehicle, a pedestrian, an animal or another object, which is moving or is stationary.

The driver assistance system 2 can comprise one or more systems, which before or during critical driving conditions intervene into drive, control or signaling devices of the vehicle F or on the basis of appropriate means which give a driver of the vehicle F warning of the critical driving conditions.

With a part of such systems, such as. e.g.. a distance alerter or an automatic adaptive cruise control, a distance D between the vehicle F and the object O is determined and the driver assistance system 2 is controlled on the basis of the determined distance D.

For determining the distance D the apparatus 1 comprises an imaging unit 1.1 and an image processing unit 1.2, wherein by means of image data recorded by the imaging unit 1.1 and processed by the image processing unit 1.2 a vehicle environment, at least the one object O in the vehicle environment and/or status data are determined.

In the shown example of embodiment the image data, i.e. the object O in the vehicle environment is detected by means of the imaging unit 1.1.

The apparatus 1 is embodied in particular as a so-called stereoscopic imaging system, in which the imaging unit 1.1 comprises two cameras not shown in detail, which are preferably arranged horizontally next to each other and which detect stereoscopically the vehicle environment and the objects O therein.

When processing the two detected images by means of the image processing unit 1.2, on the basis of at least one of the numerous stereo algorithms known from prior art coordinates of at least one pixel of the one image are compared with coordinates of a further pixel of the other image considered as potentially corresponding. From a distance of the pixels to each other, a so-called disparity, and from a known distance of the cameras arranged horizontally next to each other, the so-called base width, the distance D of an object O, to which the detected pixels pertain, to the cameras is determined.

Preferably disparities for all pixels of the images are created according to this algorithm and a disparity image and/or a disparity card is created, which represents a three-dimensional representation of the object O in its context. In this way the distance and spatial position of the object O in relation to the cameras can be detected and thus the distance D to the object can be determined.

During a travel of the vehicle F for example unevenness in a road surface, transverse accelerations q and/or longitudinal accelerations L of the vehicle F may lead to pitching, rolling and/or yawing motions of the vehicle F.

A pitching motion means here a swaying motion of the vehicle F around its transverse axis and a rolling motion means a swaying around its longitudinal axis of the vehicle F. The yawing motion is characterized by a movement of the vehicle F around its vertical axis, wherein the transverse, longitudinal and vertical axis jointly run through a center of gravity of the vehicle F.

The changes of the pitch, rolling and/or yaw angle of the vehicle F caused by the pitching, rolling and/or yawing motions lead to a pixel offset P in consecutive images detected by means of the imaging unit 1.1.

The pixel offset P caused by the changes of the pitch, rolling and/or yaw angle is characterized in that the object O or parts of the object O in the consecutive images are shown at different positions in the image, although the position of the object O to the vehicle F has not changed.

To avoid an inaccurate determination and/or representation of the vehicle environment resulting from the pixel offset P, of the object O in the vehicle environment and/or of the status data as well as in particular a resulting imprecise and/or incorrect determination of the distance D of the vehicle F to the object O, the pixel offset P present in the consecutive images is determined and compensated for.

FIG. 2 shows a possible example of embodiment of the apparatus 1 according to FIG. 1 in a detailed representation, wherein the apparatus is connected with the driver assistance system.

Apart from the imaging unit 1.1 and the image processing unit 1.2 the apparatus 1 comprises a rotation rate sensor 1.3, which is embodied as a sensor with a three-dimensional detection area—also called 3D-sensor or 3D-cluster, so that by means of the rotation rate sensor 1.3 rotation rates R of the vehicle F can be detected in such a manner that simultaneously pitch angle, rolling angle and yaw angle of the vehicle F can be determined.

For detecting the rotation rates R by means of the rotation rate sensor 1.3 a rotational speed of the vehicle F and/or of the imaging unit 1.1 around their transverse, vertical and/or longitudinal axis is determined and by integrating the rotational speed the pitch angle, yaw angle and/or rolling angle are derived from the rotational speed.

Alternatively, also three separate rotation rate sensors for determining the rotation rates R of the vehicle F can be provided.

The rotation rates R of the vehicle F are steadily supplied to a control unit 1.4, which determines from the values of the rotation rates R first a pitch angle, a rolling angle and a yaw angle of the vehicle F. Subsequently, by means of the control unit 1.4 on the basis of the pitch angles, rolling angles and/or yaw angles during at least two consecutive images a change of the pitch angle, rolling angle and/or yaw angle is determined.

From the change of the pitch angle, rolling angle and/or yaw angle a change of position of at least one pixel during the two consecutive images is derived and a pixel offset P to be expected is determined.

In doing so, the pixel offset P is determined preferably not for all pixels, but merely for a part of the pixels of the image, and from this a pixel offset P is derived for all pixels resulting in a very short processing time.

The determined pixel offset P is taken into consideration when creating the disparities, so that the disparity image and/or the disparity card represent a three-dimensional representation of the object O in its context, which are independent of the pitch angle, rolling angle and yaw angle of the vehicle F. Thus, the distance and spatial position of the object O in relation to the imaging unit 1.1 are detected while taking into consideration the pitch angle, rolling angle and yaw angle movement of the vehicle F, so that the real, unaltered distance D to the object O is determined.

As the disparity image and/or the disparity card are formed by the distances of the pixels to the imaging unit 1.1, it is necessary for an accurate determination of the pixel offset P to detect the rotation rates R of the vehicle F at the position of the imaging unit 1.1. Therefore, the rotation rate sensor 1.3 is arranged directly at or in the imaging unit 1.1, so that a conversion of the rotation rates R from another position of the vehicle F to the position of the imaging unit 1.1 is not required.

For increasing the robustness of the apparatus 1 with regard to the determination of the rotation rates R and thus of the pixel offset P, the apparatus 1 comprises additionally two acceleration sensors 1.5, 1.6 arranged vertically to each other, by means of which a longitudinal acceleration L and a transverse acceleration Q of the vehicle F are detected. The acceleration sensors 1.5, 1.6 are arranged likewise directly at or in the imaging unit 1.1.

Both the rotation rates R determined by means of the rotation rate sensor 1.3 and the longitudinal acceleration L and transverse acceleration Q of the vehicle F are detected during at least two consecutive images and are supplied the control unit 1.4.

The control unit 1.4 determines from the values of the longitudinal and transverse acceleration of the vehicle F and on the basis of a vehicle model stored in a storage unit 1.7 the rotation rates R of the vehicle F, from which in turn the change of the pitch angle, rolling angle and yaw angle of the vehicle F and thus the pixel offset P are derived.

By comparing the rotation rates R of the vehicle F determined by means of the values of the rotation rate sensor 1.3 and by means of the values of the acceleration sensors 1.5, 1.6, a plausibility check is performed by means of the control device 1.4, as a function of the latter the pixel offset P is detected and thus the robustness of the apparatus 1 is increased.

Both the rotation rate sensor 1.3 as well as the acceleration sensors 1.5, 1.6 can comprise a so-called drift of the measured rotation rate or acceleration. A drift is a change of the rotation rate or acceleration of the vehicle F which despite a constant behavior of the vehicle F is released by the rotation rate sensor 1.3 or the acceleration sensors 1.5, 1.6.

This drift, i.e. the deviation of the rotation rate or acceleration from a nominal value with the vehicle F constantly traveling straight ahead, is caused for example by changing environmental conditions, such as temperature fluctuations.

In order to avoid a falsification of the measurement values, from which results an insufficient accurate or incorrect determination of the pixel offset P and thus of the distance D to the object O, the drift, i.e. the deviation from the nominal value is determined by means of a filtration, in particular by means of a low pass filter not shown in detail.

The determined deviation is taken into consideration when determining the change of the pitch angle, rolling angle and/or yaw angle of the vehicle F, so that the measurement errors are minimized and the accuracy of the determination and/or representation of the vehicle environment, of the object O in the vehicle environment and/or of the status data as well as in particular the resulting distance D of the vehicle F to the object O is increased.

### LISTING OF REFERENCE NUMERALS

1 Apparatus

1.1 Imaging unit

1.2 Image processing unit

1.3 Rotation rate sensor

1.4 Control unit

1.5 Acceleration sensor

1.6 Acceleration sensor

1.7 Storage unit

2 Driver assistance system

D Distance

F Vehicle

L Longitudinal acceleration

Object

P Pixel offset

Q Transverse acceleration

R Rotation rate

1.-13. (canceled)

14. A method for operating a video-based driver assistance system in a vehicle (F), said method comprising the steps of:
determining a vehicle environment and/or at least one object (O) in the vehicle environment and/or status data by means of image data recorded by an imaging unit and processed by an image processing unit; and
determining and compensating for a pixel offset (P) present in the image data of consecutive images in determining the vehicle environment, the object (O) in the vehicle environment and/or the status data.

15. A method according to claim 14 further comprising the step of determining a pixel offset (P), resulting from a change of a pitch angle, yaw angle and/or rolling angle.

16. A method according to claim 15 further comprising the steps of
determining a change of position of at least one pixel in the consecutive images from the change of the pitch angle, yaw angle and/or rolling angle; and
determining an expected pixel offset (P) on the basis of the determined change of position of the pixel(s).

17. A method according to claim 15 further comprising the step of determining the change of the pitch angle, yaw angle and/or rolling angle from detected rotation rates (R) during recording of two consecutive images.

18. A method according to claim 17 further comprising the step of determining the rotation rates (R) by means of at least one rotation rate sensor during the recording of at least two consecutive images.

19. A method according to claim 18 further comprising the step of determining a longitudinal acceleration (L) and/or transverse acceleration (Q) of the vehicle (F) during the recording of at least two consecutive images by means of at least one acceleration sensor.

20. A method according to claim 19 further comprising the step of determining the rotation rates (R) from the detected longitudinal acceleration (L) and/or transverse acceleration (Q) on the basis of a vehicle model.

21. A method according to claim 18 further comprising the step of determining a deviation of the determined rotation rates (R) from a nominal value by means of a filtration in an event that the vehicle (F) is moving.

22. An apparatus for operating a video-based driver assistance system in a vehicle (F), said apparatus comprising:
an imaging unit for recording image data; and
an image processing unit for processing the image data and a control unit for determining a vehicle environment and/or at least one object (O) in the vehicle environment and/or status data from the image data,
wherein the control unit is connected with at least one rotation rate sensor and/or at least one acceleration sensor in such a manner that in the determination of the vehicle environment, of the object (O) in the vehicle environment and/or of the status data, a pixel offset (P) present in the image data of consecutive images can be determined and compensated for on the basis of detected rotation rates (R).

23. An apparatus according to claim 22, wherein the at least one rotation rate sensor and/or the at least one acceleration sensor is/are arranged directly at or in the imaging unit.

24. An apparatus according to claim 22, wherein the rotation rate sensor is a sensor with a three-dimensional detection area, by means of which a pitch angle, yaw angle and/or rolling angle of the vehicle (F) can be detected.

25. An apparatus according to claim 22 further comprising two acceleration sensors arranged at right angles to each other directly at or in the imaging unit,
wherein, by means of one of the acceleration sensors, a longitudinal acceleration (L) can be detected, and
wherein, by means of the other acceleration sensor, a transverse acceleration (Q) of the vehicle (F) can be detected.

26. An apparatus according to claim 25,
wherein a vehicle model is stored in a storage unit, and
wherein rotation rates (R) of the vehicle (F) can be determined on the basis of the vehicle model from the longitudinal acceleration (L) and/or transverse acceleration (Q).
